(19) United States
(12) Patent Application Publication
(10) Pub. No.: US 2021/0102820 A1
(43) Pub. Date: Apr. 8, 2021

(54) TRANSITIONING BETWEEN MAP VIEW AND AUGMENTED REALITY VIEW

(71) Applicant: Google LLC, Mountain View, CA (US)

(72) Inventors: Andre Le, Mountain View, CA (US); Stefan Welker, Mountain View, CA (US); Paulo Coelho, San Jose, CA (US)

(21) Appl. No.: 15/733,492

(22) PCT Filed: Feb. 23, 2018
(86) PCT No.: PCT/US2018/019499

§ 371 Date: Aug. 11, 2020

(51) Int. Cl. G01C 21/36; G06F 3/01; G06T 11/00; G09G 5/38; G06F 3/0346; G09G 5/37

(52) U.S. Cl. CPC G01C 21/3647; G01C 21/3682; G01C 21/3644; G06F 3/011; G09G 2354/00; G09G 5/38; G06F 3/0346; G09G 5/37; G06T 11/00

(57) ABSTRACT

A method includes: triggering presentation of at least a portion of a map on a device that is in a map mode, wherein a first point of interest (POI) object is placed on the map, the first POI object representing a first POI located at a first physical location; detecting, while the map is presented, an input triggering a transition of the device from the map mode to an augmented reality (AR) mode; triggering presentation of an AR view on the device in the AR mode, the AR view including an image captured by a camera of the device, the image having a field of view; determining whether the first physical location of the first POI is within the field of view; and if so, triggering placement of the first POI object at a first edge of the AR view.

### TECHNICAL FIELD

This document relates, generally, to transitioning between a map view and an augmented reality (AR) view.

### BACKGROUND

The use of AR technology has entered a number of areas already, and is continuing to be applied in new areas. Particularly, the rapid adaptation of handheld devices such as smartphones and tablets has created new opportunities to apply AR. However, a remaining challenge is to provide a user experience that is intuitive and does not require the user to endure jarring experiences.

In particular, there can be difficulties in presenting information to users using AR on smaller screens typical of smartphones and tables. This can be particularly difficult when presenting a point of interest (POI) on a map when the user is moving or facing a direction away from the POI.

### SUMMARY

In a first aspect, a method includes: triggering presentation of at least a portion of a map on a device that is in a map mode, wherein a first point of interest (POI) object is placed on the map, the first POI object representing a first POI located at a first physical location; detecting, while the map is presented, an input triggering a transition of the device from the map mode to an augmented reality (AR) mode; triggering presentation of an AR view on the device in the AR mode, the AR view including an image captured by a camera of the device, the image having a field of view; determining whether the first physical location of the first POI is within the field of view; and in response to determining that the first physical location of the first POI is not within the field of view, triggering placement of the first POI object at a first edge of the AR view.

Therefore, information regarding the existence, location or other properties of the POI can be indicated to the viewer in AR view mode even if the view being presented to the user does not include the location of the POI, e.g. they are looking or facing (or the camera is facing) a different direction. This can enhance the amount of information being supplied to the user, whilst using a smaller screen (e.g. on a smartphone or stereo goggles) without degrading the AR effect.

A map may be described as a visual representation of real physical features, e.g. on the ground or surface of the Earth. These features may be shown in their relative sizes, respective forms and relative location to each other according to a scale factor. A POI may be a map object or feature. AR mode may include providing an enhanced image or environment as displayed on a screen, goggles or other display. This may be produced by overlaying computer-generated images, sounds, or other data or objects on a view of a real-world environment, e.g. a view provided using a live-view camera or real time video. The field of view may be the field of view of a camera or cameras. The edge of the AR view may be an edge of the screen or display or an edge of a window within the display, for example.

Implementations can include any or all of the following features. The method further includes determining that the first edge is closer to the first physical location than other edges of the AR view, wherein the first edge is selected for placement of the first POI object based on the determination. Determining that the first edge is closer to the first physical location than the other edges of the AR view comprises determining a first angle between the first physical location and the first edge, determining a second angle between the first physical location and a second edge of the image, and comparing the first and second angles. Detecting the input includes, in the map mode, determining a vector corresponding to a direction of the device using an up vector of a display device on which the map is presented, determining a camera forward vector, and evaluating a dot product between the vector and a gravity vector. The first POI object is placed at the first edge of the AR view, the method further comprising: detecting a relative movement between the device and the first POI; and in response to the relative movement, triggering cessation of presentation of the first POI object at the first edge, and instead triggering presentation of the first POI object at a second edge of the image opposite the first edge. Triggering cessation of presentation of the first POI object at the first edge comprises triggering gradual motion of the first POI object out of the AR view at the first edge so that progressively less of the first POI object is visible until the first POI object is no longer visible at the first edge. Triggering presentation of the first POI object at the second edge comprises triggering gradual motion of the first POI object into the AR view at the second edge so that progressively more of the first POI object is visible until the first POI object is fully visible at the second edge. The method further comprises, after triggering cessation of presentation of the first POI object at the first edge, pausing for a predetermined time before triggering presentation of the first POI object at the second edge. The first physical location of the first POI is initially outside of the field of view and on a first side of the device, and detecting the relative movement comprises detecting that the first physical location of the first POI is instead outside of the field of view and on a second side of the device, the second side opposite to the first side. Triggering presentation of the map comprises: determining a present inclination of the device; and causing the portion of the map to be presented, the portion being determined based on the present inclination of the device. The determination comprises applying a linear relationship between the present inclination of the device and the portion. The transition of the device from the map mode to the AR mode, and a transition of the device from the AR mode to the map mode, are based on the determined present inclination of the device without use of a threshold inclination. At least a second POI object in addition to the first POI object is placed on the map in the map view, the second POI object corresponding to a navigation instruction for a traveler to traverse a route, the method further comprising: detecting a rotation of the device; in response to detecting the rotation, triggering rotation of the map based on the rotation of the device; and triggering rotation of at least part of the second POI object corresponding to the rotation of the map. The second POI object comprises an arrow symbol placed inside a location legend, wherein the part of the second POI object that is rotated corresponding to the rotation of the map includes the arrow symbol, and wherein the location legend is not rotated corresponding to the rotation of the map. The location legend is maintained in a common orientation relative to the device while the map and the arrow symbol are rotated. Multiple POI objects in addition to the first POI object are presented in the map view, the multiple POI objects corresponding to respective navigation instructions for a traveler to traverse a route, a second POI object of the multiple POI objects corresponding to a next navigation instruction on the route and being associated with a second physical location, the method further comprising: when the AR view is presented on the device in the AR mode, triggering presentation of the second POI object at a location on the image corresponding to the second physical location, and not triggering presentation of a remainder of the multiple POI objects other than the second POI object on the image. The method further comprises triggering presentation, in the map mode, of a preview of the AR view. Triggering presentation of the preview of the AR view comprises: determining a present location of the device; receiving an image from a service that provides panoramic views of locations using an image bank, the image corresponding to the present location; and generating the preview of the AR view using the received image. The method further comprises transitioning from the preview of the AR view to the image in the transition of the device from the map mode to the AR mode. The method further comprises, in response to determining that the first physical location of the first POI is within the field of view, triggering placement of the first POI object at a location in the AR view corresponding to the first physical location.

In a second aspect, a computer program product is tangibly embodied in a non-transitory storage medium, the computer program product including instructions that when executed cause a processor to perform operations as set out in any of the aspects described above.

In a third aspect, a system includes: a processor; and a computer program product tangibly embodied in a non-transitory storage medium, the computer program product including instructions that when executed cause the processor to perform operations as set out in any of the aspects described above.

It should be noted that any feature described above may be used with any particular aspect or embodiment of the invention.

### BRIEF DESCRIPTION OF DRAWINGS

FIGS. 1A-B show an example of transitioning between a map view and an AR view.

FIG. 2 shows an example of a system.

FIGS. 3A-G show another example of transitioning between a map view and an AR view.

FIGS. 4A-C show an example of maintaining an arrow symbol true to an underlying map.

FIGS. 5A-C show an example of controlling a map presence using device tilt.

FIG. 6 conceptually shows device mode depending on device tilt.

FIGS. 7-11 show examples of methods.

FIG. 12 schematically shows an example of transitioning between a map view and an AR view.

FIG. 13 shows an example of a computer device and a mobile computer device that can be used to implement the techniques described here.

Like reference symbols in the various drawings indicate like elements.

### DETAILED DESCRIPTION

This document describes examples of implementing AR functionality on a user device such as a smartphone, tablet or AR goggles. For example, approaches are described that can provide a smooth transition between a map view and an AR view on the user device. Providing a more seamless transition back-and-forth between such modes can ensure a more enjoyable, productive and useful user interaction with the device, and thereby eliminate some barriers that still remain for users to engage with AR. In so doing, the approach(es) can stimulate an even wider adoption of AR technology as a way to develop the interface between the human and the electronic device.

In some implementations, virtual and physical camera views can be aligned, and contextual anchors can be provided that may persist across all modes. AR tracking and localization can be established before entering AR mode. For example, a map can be displayed in at least two modes. One mode, which may be referred to as a 2D mode, shows a top view of the map and may be present when the user is holding the phone in a generally horizontal orientation, such as parallel to the ground. In another mode, which may be referred to as an AR mode, the map may be reduced down to a small (e.g., tilted) map view (e.g., a minimap). This can be done when the user is inclining or declining the phone compared to the horizontal position, such as by pointing the phone upright. A pass-through camera on the phone can be used in AR mode to provide better spatial context and overlay upcoming turns, nearby businesses, etc. user interface (UI) anchors such as a minimap, current position, destination, route, streets, upcoming turns, and compass direction can transition smoothly as the user switches between modes. As the UI anchors move off screen, they can dock to the edges to indicate additional content.

Some implementations provide a consistency of visual user interface anchors and feature an alignment between the virtual map and physical world. This can reduce potential user barriers against transitioning into or out of an AR mode (sometimes referred to as switching friction) and can enable seamless transitions between 2D and AR modes using natural and intuitive gestures. Initializing the tracking while still in the 2D mode of a piece of software, such as an app, can make the transition to AR much quicker.

In some implementations, using different phone orientations in upright and horizontal mode to determine the user facing direction can help avoid the gimbal lock problem and thus provide a stable experience. Implementations can provide that accuracy of tracking and the use case are well aligned. Accurate position tracking can be challenging when facing down. For example, errors and jittering in the position may be easily visible when using GPS or the camera for tracking. When holding the phone facing the ground, there may be less distinguishing features available for accurately determining one's position from visual features or VPS. When holding the phone up, AR content may be further away from the user, and a small error/noise in the position of the phone may not show in the AR content.

While some implementations described here mention AR as an example, the present subject matter can also or instead be applied with virtual reality (VR). In some implementations, corresponding adjustments to the examples described herein can then be made. For example, a device can operate according to a VR mode; a VR view or a VR area can be presented on a device; and a user can have a head-mounted display such as a pair of VR goggles.

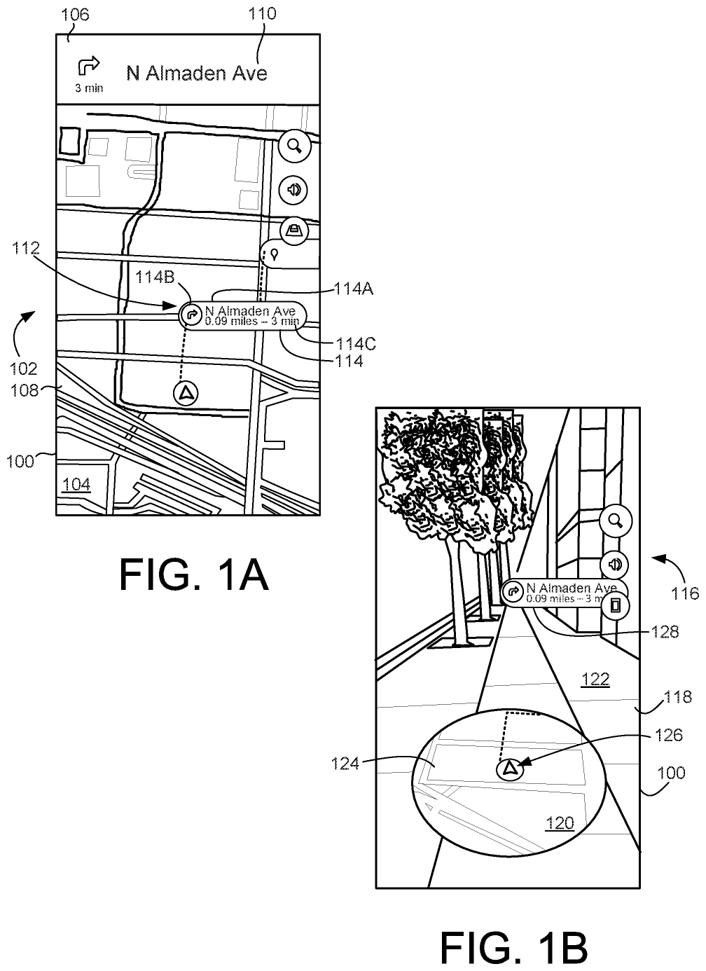

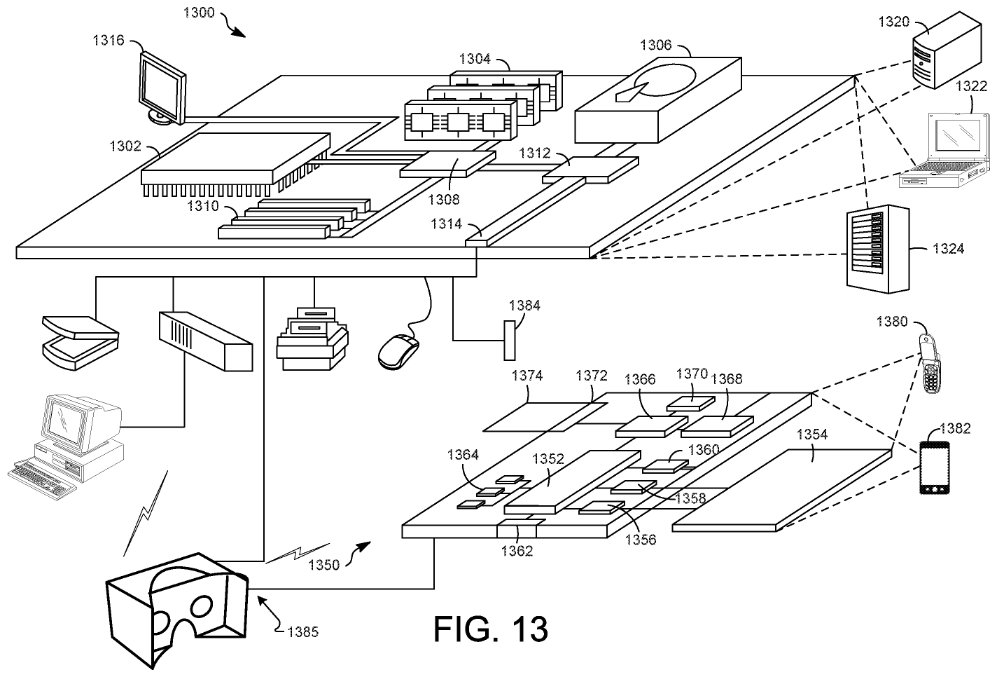

FIGS. 1A-B show an example of transitioning between a map view and an AR view. These and other implementations described herein can be provided on a device such as the one(s) shown or described below with regard to FIG. 13. For example, such a device can include, but is not limited to, a smartphone, a tablet or a head-mounted display such as a pair of AR goggles.

In the example shown in FIG. 1A, the device has at least one display, including, but not limited to, a touchscreen panel. Here, a graphical user interface (GUI) 100 is presented on the display. A navigation function is active on the GUI 100. For example, the navigation function can be provided by local software (e.g., an app on a smartphone) or it can be delivered from another system, such as from a server. Combinations of these approaches can be used.

The navigation function is presenting a map view 102 in the GUI 100. This can occur in the context of the device being in a map mode (sometimes referred to as a 2D mode), which can be distinct from, or co-existent with, another available mode, including, but not limited to, an AR mode. In the present map mode, the map view 102 includes a map area 104 and a direction presentation area 106. The map area 104 can present one or more maps 108 and the direction presentation area 106 can present one or more directions 110.

In the map area 104, one or more routes 112 can be presented. The route(s) can be marked between at least the user's present position and at least one point of interest (POI), such as a turn along the route, or the destination of the route, or interesting features along the way. Here, a POI object 114 is placed along the route 112 to signify that a right turn should be made at N Almaden Avenue. The POI object 114 can include one or more items. Here, the POI object 114 includes a location legend 114A which can serve to contain the (in this case) information about the POI (such as a turn), an arrow symbol 114B (here signifying a right turn) and text content 114C with information about the POI represented by the POI object 114. Other items can be presented in addition to, or in lieu of, one or more of the shown items of the POI object 114. While only a single POI object 114 is shown in this example, in some implementations the route 112 can include multiple POI objects.

In the example shown in FIG. 1B, the GUI 100 is presenting an AR view 116. The AR view 116 can be presented in the context of when the device is in an AR mode (sometimes referred to as a 3D mode), which can be distinct from, or co-existent with, another available mode, including, but not limited to, a map mode. In the present AR mode, the AR view 116 presents an image area 118 and a map area 120. The image area 118 can present one or more images 122 and the map area 120 can present one or more maps 124. For example, the image 122 can be captured by a sensor associated with the device presenting the GUI 100, including, but not limited to, by a camera of a smartphone device. As another example, the image 122 can be an image obtained from another system (e.g., from a server) that was captured at or near the current position of the device presenting the GUI 100.

The current position of the device presenting the GUI 100 can be indicated on the map 124. Here, an arrow 126 on the map 124 indicates the device location relative to the map 124. Although the placement of the arrow 126 is based on the location of the device (e.g., determined using location functionality), this is sometimes referred to as the user's position as well. The arrow 126 can remain at a predefined location of the map area 120 as the device is moved. For example, the arrow 126 can remain in the center of the map area 120. In some implementations, when the user rotates the device, the map 124 can rotate around the arrow 126, which can provide an intuitive experience for the user.

One or more POI objects can be shown in the map area 120 and/or in the image area 118. Here, a POI object 128 is placed at a location of the image 122. The POI object 128 here corresponds to the POI object 114 (FIG. 1A). As such, the POI object 128 represents the instruction to make a right turn at N Almaden Avenue. That is, N Almaden Avenue is a physical location that can be represented on the map 108 and in the AR view 116. In some implementations, the POI object 114 (FIG. 1A) can be associated with a location on the map 108 that corresponds to the physical location of N Almaden Avenue. Similarly, the POI object 128 can be associated with a location on the image that corresponds to the same physical location. For example, the POI object 114 can be placed at the map location on the map 108, and the POI object 128 can be presented on the image 122 as the user traverses the remaining distance before reaching the physical location of N Almaden Avenue.

In some implementations, the POI object 128 may have been transitioned from the map 108 (FIG. 1A) as part of a transition into the AR mode. For example, the POI object 128 here corresponds to an instruction to make a turn as part of traversing a navigation route, and other objects corresponding to respective POIs of the navigation may have been temporarily omitted so that the POI object 128 is currently the only one of them that is presented.

One or more types of input can cause a transition from a map mode (e.g., as in FIG. 1A) to an AR mode (e.g., as in FIG. 1B). In some implementations, a maneuvering of the device can be recognized as such an input. For example, holding the device horizontal (e.g., aimed toward the ground) can cause the map view 102 to be presented as in FIG. 1A. For example, holding the device angled towards the horizontal plane (e.g., tilted or upright) can cause the AR view 116 to be presented as in FIG. 1B. In some implementations, some or all of the foregoing can be caused by detection of another input. For example, a specific physical or virtual button can be actuated. For example, a gesture performed on a touchscreen can be recognized.

The map view 102 and the AR view 116 are examples of how multiple POI objects in addition to the POI object 114 can be presented in the map view 102. The multiple POI objects can correspond to respective navigation instructions for a traveler to traverse the route 112. In the AR view 116, the POI object 128, as one of the multiple POI objects, can correspond to a next navigation instruction on the route and accordingly be associated with the physical location of N Almaden Avenue. As such, when the AR view 116 is presented on the device in the AR mode, the POI object 128 can be presented at a location on the image 122 corresponding to the physical location of N Almaden Avenue. Moreover, a remainder of the multiple POI objects associated with the route 112 (FIG. 1A) may not presently appear on the image 122.

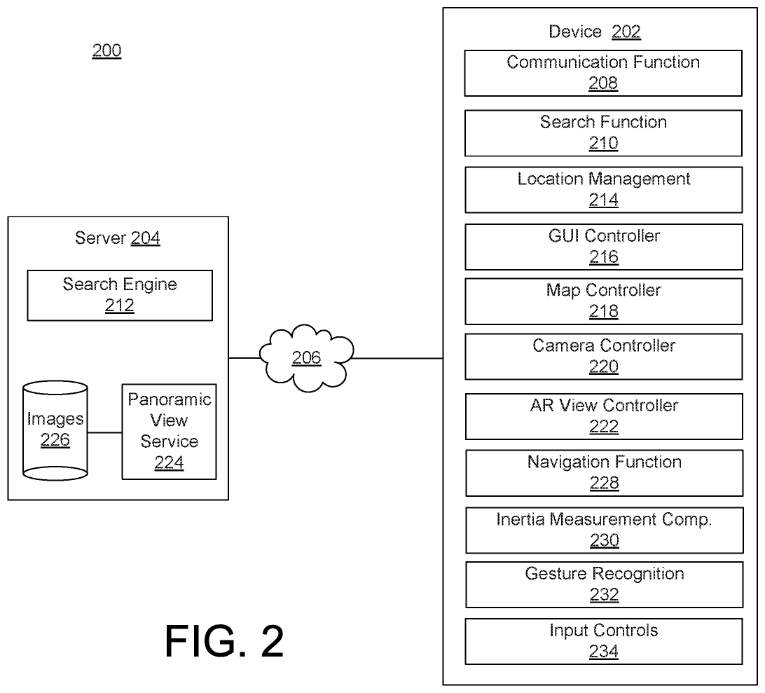

FIG. 2 shows an example of a system 200. The system 200 can be used for presenting at least one map view and at least one AR view, for example as described elsewhere herein. The system 200 includes a device 202 and at least one server 204 that can be communicatively coupled through at least one network 206, such as a private network or the internet. Either or both of the device 202 and the server 204 can operate in accordance with the devices or systems described below with reference to FIG. 13.

The device 202 can have at least one communication function 208. For example, the communication function 208 allows the device 202 to communicate with one or more other devices or systems, including, but not limited to, with the server 204.

The device 202 can have at least one search function 210. In some implementations, the search function 210 allows the device 202 to run searches that can identify POIs (e.g., interesting places or events, and/or POIs corresponding to navigation destinations or waypoints of a route to a destination). For example, the server 204 can have at least one search engine 212 that can provide search results to the device 202 relating to POIs.

The device 202 can have at least one location management component 214. In some implementations, the location management component 214 can provide location services to the device 202 for determining or estimating the physical location of the device 202. For example, one or more signals such as a global positioning system (GPS) signal or another wireless or optical signal can be used by the location management component 214.

The device 202 can include at least one GUI controller 216 that can control what and how things are presented on the display of the device. For example, the GUI controller regulates when a map view, or an AR view, or both should be presented to the user.

The device 202 can include at least one map controller 218 that can control the selection and tailoring of a map to be presented to the user. For example, the map controller 218 can select a portion of a map based on the current location of the device and cause that portion to be presented to the user in a map view.

The device 202 can have at least one camera controller 220 that can control a camera integrated into, connected to, or otherwise coupled to the device 202. For example, the camera controller can capture an essentially live stream of image content (e.g., a camera passthrough feed) that can be presented to the user.

The device 202 can have at least one AR view controller 222 that can control one or more AR views on the device. In some implementations, the AR controller can provide live camera content, or AR preview content, or both, for presentation to the user. For example, a live camera feed can be obtained using the camera controller 220. For example, AR preview images can be obtained from a panoramic view service 224 on the server 204. The panoramic view service 224 can have access to images in an image bank 226 and can use the image(s) to assemble a panoramic view based on a specified location. For example, the images in the image bank 226 may have been collected by capturing images content while traveling on roads, streets, sidewalks or other public places in one or more countries. Accordingly, for one or more specified locations on such a canvassed public location, the panoramic view service 224 can assemble a panoramic view image that represents such location(s).

The device 202 can include at least one navigation function 228 that can allow the user to define routes to one or more destinations and to receive instructions for traversing the routes. For example, the navigation function 228 can recognize the current physical position of the device 202, correlate that position with coordinates of a defined navigation route, and ensure that the traveler is presented with the (remaining) travel directions to traverse the route from the present position to the destination.

The device 202 can include at least one inertia measurement component 230 that can use one or more techniques for determining a spatial orientation of the device 202. In some implementations, an accelerometer and/or a gyroscope can be used. For example, the inertia measurement component 230 can determine whether and/or to what extent the device 202 is currently inclined with regard to some reference, such as a horizontal or vertical direction.

The device 202 can include at least one gesture recognition component 232 that can recognize one or more gestures made by the user. In some implementations, a touchscreen device can register hand movement and/or a camera can register facial or other body movements, and the gesture recognition component 232 can recognize these as corresponding to one or more predefined commands. For example, this can activate a map mode and/or an AR mode and/or both.

Other inputs than gestures and measured inclination can be registered. The device 202 can include input controls 234 that can trigger one or more operations by the device 202, such as those described herein. For example, the map mode and/or the AR mode can be invoked using the input control(s) 234.

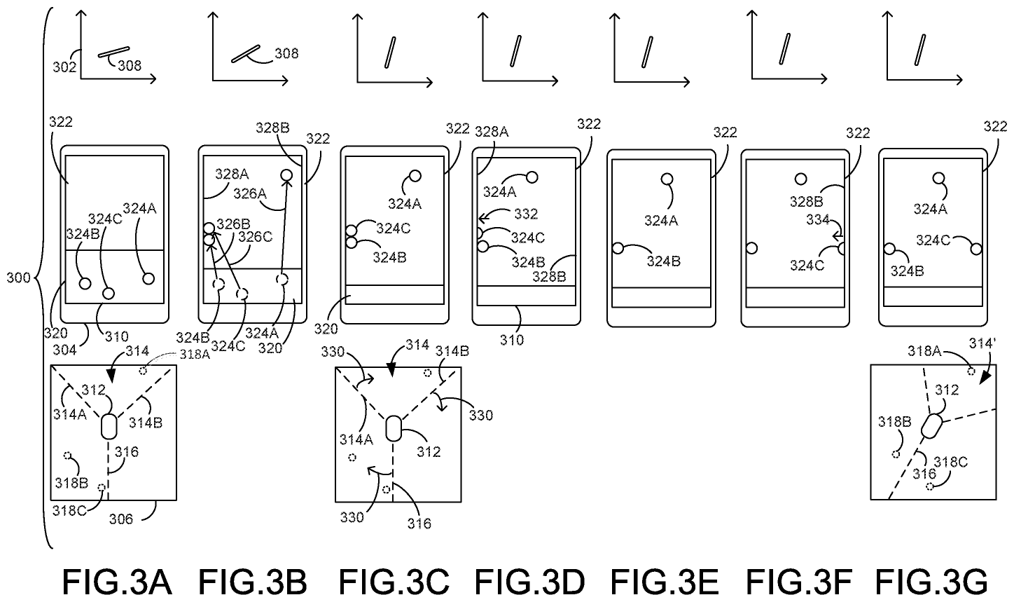

FIGS. 3A-G show another example of transitioning between a map view and an AR view. This example includes a gallery 300 of illustrations that are shown at different points in time corresponding to the respective ones of FIGS. 3A-G. Each point in time is here represented by one or more of: an inclination diagram 302, a device 304 and a map 306 of physical locations. For example, in the inclination diagram 302 the orientation of a device 308 can be indicated; the device 304 can present content such as a map view and/or an AR view on a GUI 310; and/or in the map 306 the orientation of a device 312 relative to one or more POIs can be indicated.

The devices 304, 308 and 312 are shown separately for clarity, but are related to each other in the sense that the orientation of the device 308 and/or the device 312 can cause the device 304 to present certain content on the GUI 310.

The device 304, 308 or 312 can have one or more cameras or other electromagnetic sensors. For example, in the map 306, a field of view (FOV) 314 can be defined by respective boundaries 314A-B. The FOV 314 can define, for example, what is captured by the device's camera depending on its present position and orientation. A line 316, moreover, extends rearward from the device 312. In a sense, the line 316 defines what objects are to the left or to the right of the device 312, at least with regard to those objects that are situated behind the device 312 from the user's perspective.

Multiple physical locations 318A-C are here marked in the map 306. These can correspond to the respective physical locations of one or more POIs that have been defined or identified (e.g., by way of a search function or navigation function). For example, each POI can be a place or event, a waypoint and/or a destination on a route. In this example, a physical location 318A is currently located in front of the device 312 and within the FOV 314. A physical location 318B is located behind the device 312 and not within the FOV 314. Another physical location 318C, finally, is also located behind the device 312 and not within the FOV 314. While both of the physical locations 318B-C are here positioned to the left of the device 312, the physical location 318C is currently closer to the line 316 than is the physical location 318B.

On the device 304, the GUI 310 here includes a map area 320 and an AR area 322. In the map area, POI objects 324A-C are currently visible. The POI object 324A here is associated with the POI that is situated at the physical location 318A. Similarly, the POI object 324B is here associated with the POI of the physical location 318B, and the POI object 324C is associated with the POI of the physical location 318C, respectively. As such, the user can inspect the POI objects 324A-C in the map area 320 to gain insight into the positions of the POIs. The map area 320 can have any suitable shape and/or orientation. In some implementations, the map area 320 can be similar or identical to any map area described herein. For example, and without limitation, the map area 320 can be similar or identical to the map area 104 (FIG. 1A) or to the map 124 (FIG. 1B).

Assume now that the user makes a recognizable input into the device 304. For example, the user changes the inclination of the device 308 from that shown in FIG. 3A to that of FIG. 3B. This can cause one or more changes to occur on the device 304. In some implementations, the map area 320 can recede. For example, the amount of the map area 320 visible on the GUI 310 can be proportional to, or otherwise have a direct relationship with, the inclination of the device 308.

Another change based on the difference in inclination can be a transition of one or more POI objects in the GUI 310. Any of multiple kinds of transitions can be done. For example, the system can determine that the physical location 318A is within the FOV 314. Based on this, transition of the POI object 324A can be triggered, as schematically indicated by an arrow 326A, to a location within the AR area 322 that corresponds to the physical location 318A. In some implementations, software being executed on the device 304 triggers transition of content by causing the device 304 to transition that content on one or more screens. For example, if the AR area 322 contains an image depicting one or more physical locations, the POI object 324A can be placed on that image in a position that corresponds to the physical location of the POI at issue. As such, the transition according to the arrow 326A exemplifies that, in response to determining that the physical location 318A of the POI to which the POI object 324A corresponds is within the FOV 314, the POI object 324A can be placed at a location in the AR area 322 corresponding to the physical location 318A.

As another example, docking of one or more POI objects at an edge or edges of the GUI 310 can be triggered. In some implementations, software being executed on the device 304 triggers docking of content by causing the device 304 to dock that content on one or more screens. Here, the system can determine that the physical location 318B is not within the FOV 314. Based on this, the POI object 324B can be transitioned, as schematically indicated by an arrow 326B, to an edge of the AR area 322. In some implementations, docking at an edge of the AR area 322 can include docking at an edge of an image presented on the GUI 310. For example, the POI object 324B, which is associated with the POI of the physical location 318B, can be placed at a side edge 328A that is closest to the physical location of that POI, here the physical location 318B. As such, the transition according to the arrow 326B exemplifies that it can be determined that the side edge 328A is closer to the physical location 318B than other edges (e.g., an opposite side edge 328B) of the image. The side edge 328A can then be selected for placement of the POI object 324B based on that determination.

Similarly, the system can determine that the physical location 318C is not within the FOV 314. Based on this, transition of the POI object 324C can be triggered, as schematically indicated by an arrow 326C, to the side edge 328A. That is, the POI object 324C, which is associated with the POI of the physical location 318C, can be placed at the side edge 328A that is closest to the physical location of that POI, here the physical location 318C. As such, the transition according to the arrow 326C exemplifies that it can be determined that the side edge 328A is closer to the physical location 318C than other edges (e.g., the opposite side edge 328B) of the image. The side edge 328A can then be selected for placement of the POI object 324C based on that determination.

In some implementations, determinations such as those exemplified above can involve comparisons of angles. For example, determining that the side edge 328A is closer to the physical location 318B than, say, the opposite side edge 328B, can include a determination of an angle between the physical location 318B and the side edge 328A. For example, determining that the side edge 328A is closer to the physical location 318B can include a determination of an angle between the physical location 318B and the opposite side edge 328B. The se angles can then be compared to make the determination.

Assume now that the user further inclines the device 308 relative to the horizontal plane. FIG. 3C illustrates an example that further recession of the map area 320 can be triggered in response. In some implementations, software being executed on the device 304 triggers recession of content by causing the device to recede that content on one or more screens. For example, the map area 320 can be proportional or in another way directly dependent on the amount of tilt. This can allow more of the AR area 322 to be visible, in which the POI objects 324A-C are located.

Assume now that the user rotates the device 312 in some direction. For example, FIG. 3C illustrates that the device 312 is rotated clockwise in an essentially horizontal plane, as schematically illustrated by arrows 330. This is going to change the FOV 314, as defined by the lines 314A-B, and also the line 316. Eventually, the device 312 may have the orientation shown in FIG. 3G as a result of such a rotation. That is, the device 312 then has an orientation where a modified FOV 314′ includes the physical location 318A but neither of the physical locations 318B-C. The physical location 318B, moreover, continues to be situated behind and to the left of the device 312, because the physical location 318B is on the same side of the line 316 as in, say, FIG. 3A.

While rotation is mentioned as an example, this is not the only action that can occur and cause transitions. Rather, any relative movement between the device 312 and one or more of the physical locations 318A-C can occur and be recognized. For example, the device 312 can move, one or more of the physical locations 318A-C can move, or a combination thereof.

The physical location 318C, moreover, also continues to be situated behind device 312 in FIG. 3G. However, the physical location 318C is no longer on the same side of the line 316 as in, say, FIG. 3A. Rather, in FIG. 3G the physical location 318C is situated behind and to the right of the device 312. This may or may not cause one or more transitions in the GUI 310, as will be exemplified with reference to FIGS. 3D-G.

Transition of the POI object 324A to another location in the AR area 322 corresponding to the new FOV 314′can be triggered, for example as shown in FIG. 3D.

With respect to the POI object 324B, no transition may occur. For example, the POI object 324B continues to be situated behind and to the left of the device 312 as it was in, say, FIG. 3A. In FIG. 3D, therefore, the POI object 324B may have the same position—here, docked against the side edge 328A—as it had in FIG. 3C, before the rotation of the device 312.

A transition may occur with regard to the POI object 324C. Here, the POI object 324C is associated with the POI that has the physical location 318C. The physical location 318C, moreover, was behind and to the left of the device 312 in FIG. 3A, and is behind and to the right of the device 312 in FIG. 3G. It may therefore be helpful for the user to se the POI object 324C placed elsewhere in the GUI 310, for example as will now be described.

Transition of the POI object 324C from one (e.g., side, upper or lower) edge to another (e.g., side, upper or lower) edge can be triggered. For example, the transition can be performed from an edge of the AR area 322 (e.g., from an edge of an image contained therein). In some implementations, the POI object 324C can transition from the side edge 328A to the opposite side edge 328B. For example, the POI object 324C can perform what can be referred to as a “hide” transition. A hide transition can include a cessation of presentation of the POI object 324C. FIG. 3D shows, as schematically indicated by an arrow 332, that cessation of presentation of the POI object 324C can include a gradual motion of the POI object 324C past the side edge 328A and “out of” the GUI 310. This can be an animated sequence performed on the POI object 324C. For example, gradually less of the POI object 324C can be visible inside the side edge 328A until the POI object 324C has exited the AR area 322, such as illustrated in FIG. 3E. That is, in FIG. 3E the POI objects 324A-B remain visible, and the POI object 324C is not visible.

The situation depicted in FIG. 3E can be essentially instantaneous or can exist for some time, such as a predetermined period of time. That is, if the POI object 324C remains invisible (as in FIG. 3E) for some noticeable extent of time after transitioning past the side edge 328A, this can be an intuitive signal to the user that some transition is underway regarding the POI object 324C. For example, pausing for a predetermined time before triggering presentation of the POI object 324A at the opposite side edge 328B can follow after triggering the cessation of presentation of the POI object 324C.

Transition of the POI object 324C into the AR area 322 at another edge—essentially immediately or after some period of time—can be triggered. FIG. 3F shows an example that the POI object 324C performs a “peek in” transition at the opposite side edge 328B. This can be an animated sequence performed on the POI object 324C. A peek-in transition can include gradual motion of the POI object 324C into the AR area 322. For example, gradually more of the POI object 324C can become visible inside the opposite side edge 328B, as schematically indicated by an arrow 332, until the POI object 324C is fully visible in the AR area 322, such as illustrated in FIG. 3G. That is, in FIG. 3G the POI objects 324A-C are all visible. The POI objects 324B-C are docked at respective edges of the AR area 322 because they are associated with POIs whose physical locations are not within the FOV 314′.

The above examples illustrate a method that can include triggering presentation of at least a portion of a map in the map area 320 on the device 304 which is in a map mode. The POI object 324C can be placed on the map, the POI object 324C representing a POI located at the physical location 318C. While the map is presented, an input can be detected that triggers a transition of the device 304 from the map mode to an AR mode. In the AR mode, presentation of the AR area 322 on the device 304 can be triggered. The AR area 322 can include an image captured by a camera of the device, the image having the FOV 314. It can be determined whether the physical location 318C of the POI is within the FOV 314. In response to determining that the physical location 318C of the POI is not within the FOV 314, placement of the POI object 324C at the side edge 328A of the image can be triggered.

That is, the above examples illustrate that the physical location 318C—which is associated with one of the POIs—is initially outside of the FOV 314 (e.g., in FIG. 3A) and on a left side of the device 312 as indicated by the line 316. Detecting the relative movement can then include detecting (e.g., during the transition that results in the configuration of FIG. 3G) that the physical location 318C is instead outside of the FOV 314′ and on the right side of the device 312.

The above examples illustrate that when the POI object 324C is placed at the side edge 328A of the image, the method can further include detecting a relative movement between the device 312 and the POI. In response to the relative movement, one can cease to present the POI object 324C at the side edge 328A, and instead present the POI object 324C at the opposite side edge 328B of the image.

The above examples illustrate that ceasing to present the POI object 324C at the side edge 328A can include gradually moving the POI object 324C out of the image at the side edge 328A so that progressively less of the POI object 324C is visible until the POI object 324C is no longer visible at the side edge 328A.

The above examples illustrate that after ceasing to present the POI object 324C at the side edge 328A, a system or device can pause for a predetermined time before presenting the POI object 324C at the opposite side edge 328B.

The above examples illustrate that presenting the POI object 324C at the opposite side edge 328B can include gradually moving the POI object 324C into the image at the opposite side edge 328B so that progressively more of the POI object 324C is visible until the POI object 324C is fully visible at the opposite side edge 328B.

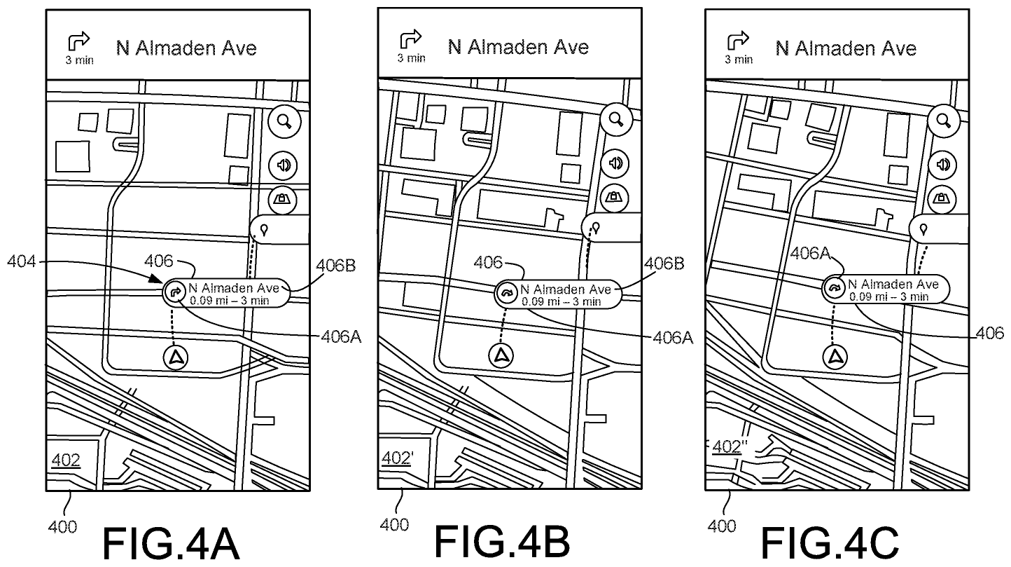

FIGS. 4A-C show an example of maintaining an arrow symbol true to an underlying map. The examples relate to a GUI 400 that can be presented on a device, such as any or all of the devices described elsewhere herein. For example, the GUI 400 can correspond to the GUI 100 in FIG. 1A.

FIG. 4A shows that the GUI 400 includes a map 402. On the map 402 is currently marked a route 404. The route 404 can extend from an origin (e.g., an initial location or a current device location) to one or more destinations. One or more navigation instructions can be provided along the route 404. Here, a location legend 406 indicates that the traveler of the route 404 should make a right turn at N Almaden Avenue. The location legend 406 includes an arrow symbol 406A and text content 406B. The arrow of the arrow symbol 406A is currently aligned with the direction of the avenue at issue (N Almaden Avenue).

Assume that the user rotates the device on which the GUI 400 is presented. FIG. 4B illustrates that a map 402′ is visible in the GUI 400. The map 402/corresponds to a certain movement (e.g., a rotation) of the map 402 that was presented in FIG. 4A. As a result of this movement or rotation, the avenue may not have the same direction in the map 402′ as in the map 402. The arrow symbol 406A can be transitioned to address this situation. For example, in FIG. 4B the arrow symbol 406A has been rotated compared to its orientation in FIG. 4A so that the arrow of the arrow symbol 406A continues to be aligned with the direction of the avenue at issue (N Almaden Avenue). A remainder of the location legend 406 may not undergo transition. For example, the text content 406B continues to be oriented in the same way as it was in FIG. 4A. FIG. 4C shows that a map 402″ is presented in the GUI 400 as a result of further movement/rotation. The arrow symbol 406A can be further rotated compared to its orientation in FIGS. 4A-B so that the arrow of the arrow symbol 406A continues to be aligned with the direction of the avenue at issue (N Almaden Avenue). A remainder of the location legend 406 may not undergo transition and may continue to be oriented in the same way as it was in FIGS. 4A-B.

The above examples illustrate that the location legend 406 is a POI object that can be placed on the map 402. The location legend 406 can correspond to a navigation instruction for a traveler to traverse the route 404. A rotation of the device generating the GUI 400 can be detected. In response to detecting the rotation, the map 402 can be rotated into the map 402′ based on the rotation of the device. At least part of the location legend 406 can be rotated corresponding to the rotation of the map 402′.

The above examples illustrate that the POI object can include the arrow symbol 406A placed inside the location legend 406. The part of the location legend 406 that is rotated corresponding to the rotation of the map 402′ can include the arrow symbol 406A. The remainder of the location legend 406 may not be rotated corresponding to the rotation of the map 402′. The remainder of the location legend 406 can be maintained in a common orientation relative to the device while the map (402′ and/or 402″) and the arrow symbol 406A are rotated. For example, in FIGS. 4A-B the remainder of the location legend 406 has an orientation where its top and bottom edges are parallel to the top and bottom edges of the GUI 400. In FIG. 4C, moreover, the remainder of the location legend 406 also has its top and bottom edges parallel to the top and bottom edges of the GUI 400. The remainder of the location legend 406 therefore has a common orientation relative to the device, whereas the map (402′ and/or 402″) and the arrow symbol 406A are rotated.

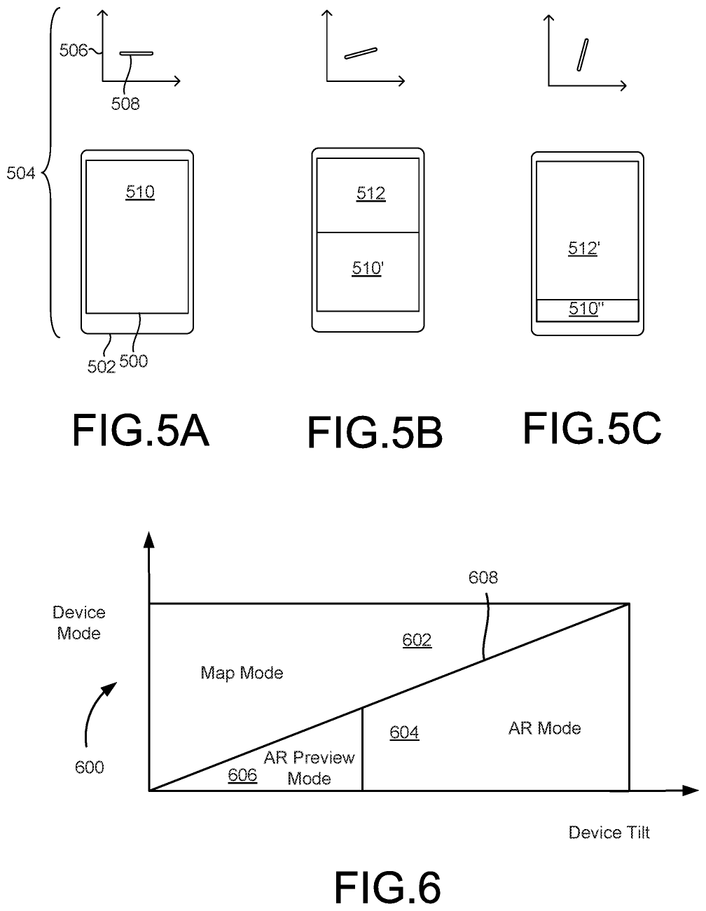

FIGS. 5A-C show an example of controlling a map presence using device tilt. The examples relate to a GUI 500 that can be presented on a device 502, such as any or all of the devices described elsewhere herein. For example, the GUI 500 can correspond to the GUI 310 in FIGS. 3A-G.

This example includes a gallery 504 of illustrations that are shown at different points in time corresponding to the respective ones of FIGS. 5A-C. Each point in time is here represented by one or more of an inclination diagram 506 and the device 502. For example, in the inclination diagram 506 the orientation of a device 508 can be indicated and/or the device 502 can present content in the GUI 500.

The GUI 500 includes a map area 510 as shown in FIG. 5A. The map area 510 currently occupies the entire GUI 500. An input can be received, such as change in inclination of the device 508. For example, FIG. 5B shows that the device 508 is more tilted than before. In response, one or more transitions can be performed. In some implementations, the map area 510 can change in size. For example, FIG. 5B shows that a map area 510′ is receded compared to the map area 510 in FIG. 5A. One or more other areas can instead or in addition be presented in the GUI 500. For example, in FIG. 5B an AR area 512 is being presented in association with the map area 510′. Further input—such as further tilting of the device 508—can result in further transition. For example, FIG. 5C shows that a map area 510″ is presented that is receded compared to the map areas 510 and 510′. Accordingly, an AR area 512′ can be presented.

The recession of the map area (510, 510′, 510″) can be directly related to the input, such as to the amount of tilt. In some implementations, the map area (510, 510′, 510″) has a size that is proportional to the amount of tilt of the device 508. For example, this means that there is not a particular threshold or trigger point where the map area (510, 510′, 510″) begins to recede; rather, the size of the map area can dynamically be adjusted based on the input. That is, instead of using an animated sequence where the map area (510, 510′, 510″) increases or decreases in size, the size can be directly determined based on the input (e.g., amount of tilt). This can provide a more intuitive and user friendly experience because the user is always fully in control of how much of the map area (510, 510′, 510″) should be visible. Also, the device behavior fosters an understanding of what causes the map area to change its size because the user can see the direct correlation between the input made (e.g., the tilt) and the resulting GUI 500. This can stand in contrast to, say, an animated sequence triggered by a threshold, such as the sudden switch between portrait mode and landscape mode on some smartphones and tablet devices. Such transitions are typically animated—that is, there is no direct relationship between the state of the transitioned screen element and the input that is driving the transition. Rather, they are usually based on the use of a threshold setting, such that when the user has tilted the device by a sufficient amount, the threshold is suddenly met and the animated transition is launched. The experience can be jarring to the user because before the threshold is reached, there is often no perceptible indication that the transition is about to happen.

The above examples illustrate that presenting the map (510, 510′, 510″) can include determining a present inclination of the device 508, and causing at least a portion of the map in the map area 510 to be presented. The portion can be determined based on the present inclination of the device 508. The determination can include applying a linear relationship between the present inclination of the device 508 and the portion of the map in the map area 510. Reciprocity can be applied. The transition of the device 502 from the map mode to the AR mode, and another transition of the device 502 from the AR mode to the map mode, can be based on the determined present inclination of the device 508 without use of a threshold inclination in the inclination diagram 506.

In some implementations, the AR area (512, 512′) can include one or more images captured using a camera of the device 502. For example, the camera can deliver an essentially live stream of passthrough images of the environment toward which the camera is aimed.

In some implementations, the AR area (512, 512′) can include a preview AR view. For example, assume that the device 508 has the orientation shown in FIG. 5A (e.g., essentially parallel to a horizontal plane) or the orientation shown in FIG. 5B (e.g., somewhat tilted up from the horizontal plane). In both these orientations, the (forward facing) camera of the device 508 may essentially be directed toward the ground. However, seeing a view of the pavement or other ground surface may not help orient the user in relation to large-scale structures such as roads, streets, buildings or other landmarks. As such, in that situation a live feed of image content from the camera may have relatively less relevance to the user.

An AR preview can therefore be presented in some situations. In some implementations, the AR area 512 in FIG. 5B does not include a live stream of image content from the camera. Rather, the AR area 512 can present the user another view that may be more helpful. For example, a previously captured image of the location towards which the camera of the device 508 is aimed can be presented.

A service can be accessed that stores image content captured in environments such as streets, highways, town squares and other places. For example, the panoramic view service 224 (FIG. 1) can provide such functionality. The panoramic view service 224 can access the image bank 226—here stored on the same server 204—and provide that content to the device 502. For example, the device 502 can determine its present location—such as using the location management component 214 (FIG. 2) and can request the panoramic view service 224, which can provide panoramic views of locations upon request, to provide one or more panoramic views based on that present location. The panoramic view(s) of the at least one received image can be presented in the AR area (512, 512′) as an AR preview. In a sense, the preview of the AR area (512, 512′) can indicate to the user what they might see if they lifted their gaze from the device 502, or if they raised the device 508 more upright, such as in the illustration of FIG. 5C. This functionality can ease the transition for the user between a map mode (such as the one in FIG. 5A) and an AR mode (such as the one in FIG. 5C). The device 502 can transition from the preview of the AR area (512, 512′) into a presentation of the AR area (512, 512′) itself. For example, the device 502 can gradually blend out the preview image and gradually blend in a live image from the camera of the device.

That is, a map mode and an AR mode can exist separately of each other, or can in a sense coexist on the user's device. FIG. 6 conceptually shows device mode depending on device tilt. This example is illustrated using a chart 600, on which the horizontal axis corresponds to respective device inputs, here the degree of tilt with regard to a reference, and the vertical axis corresponds to the mode of the device as a function of the input/tilt. At no or relatively small tilt (e.g., relative to a horizontal axis), the device can be exclusively or predominantly in a map mode 602, for example as illustrated in other examples herein. At a full or a relatively large tilt, the device can be exclusively or predominantly in an AR mode 604, for example as illustrated in other examples herein. When the tilt is relatively small, the device can optionally also be in an AR preview mode 606, for example as illustrated in other examples herein.

The chart 600 can conceptually illustrate an aspect of a transition between a map view and an AR view. A boundary 608 between, on the one hand, the map mode 602, and on the other hand, the AR mode 604 and/or the AR preview mode 606, can illustrate a dynamically adjustable size of an area, such as the map area 320 in FIGS. 3A-G, or map area (510, 510′, 510″) in FIGS. 5A-C. In some implementations, the boundary 608 can schematically represent a proportion between two or more device modes (e.g., the map mode 602, AR mode 604 and/or AR preview mode 606) depending on how much the device is inclined or declined relative to a horizontal plane. For example, the size of a map area can be directly proportional to an amount of device tilt.

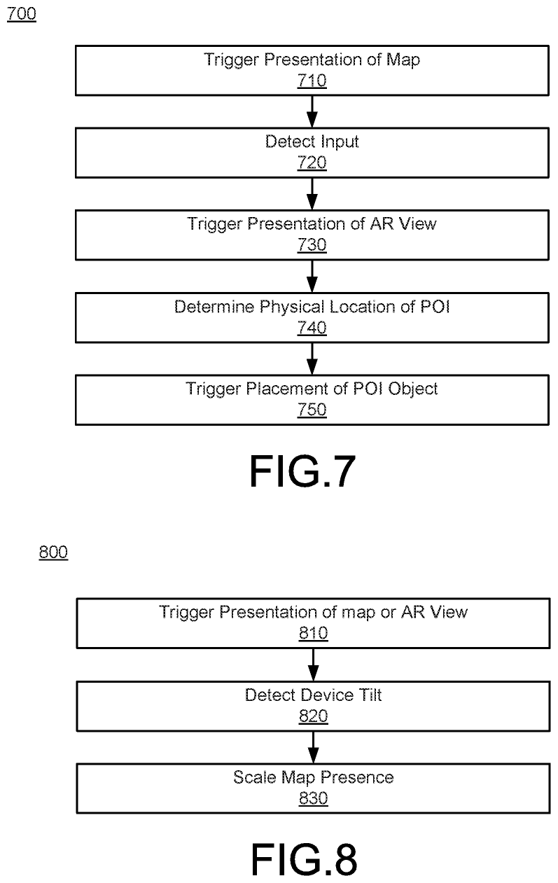

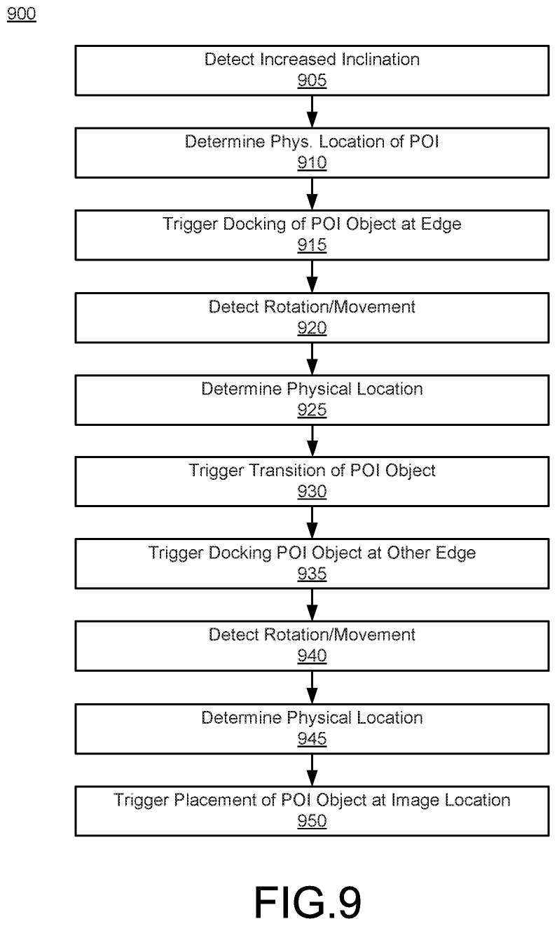

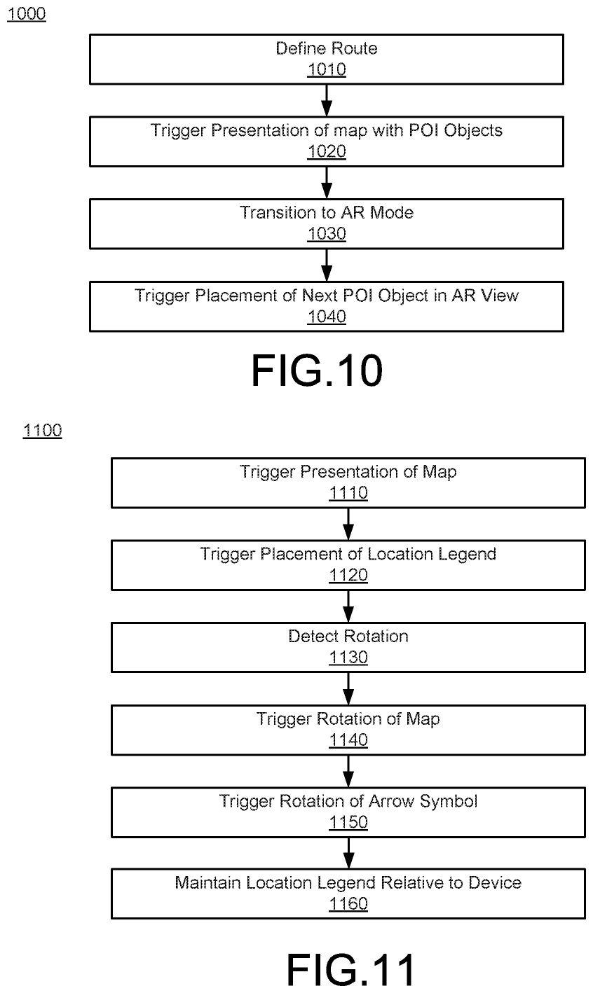

FIGS. 7-11 show examples of methods 700, 800, 900, 1000 and 1100, respectively. The methods 700, 800, 900, 1000 and 1100 can be performed by execution of instructions stored in a computer readable medium, for example in any of the devices or systems described with reference to FIG. 13. More or fewer operations than shown can be performed. Two or more operations can be performed in a different order.

At 710, presentation of a map can be triggered. In some implementations, software being executed on a device presents content by causing the device to display that content on one or more screens. For example, a map area can be presented in the map area 320 (FIG. 3A).

At 720, an input can be detected. For example, the tilt of the device 308 between FIGS. 3A-B can be detected.

At 730, presentation of an AR view can be triggered. For example, the AR area 322 in FIG. 3B can be presented.

At 740, a physical location of a POI can be determined. For example, in FIG. 3BG the physical location 318C of the POI associated with the POI object 324C can be determined.

At 750, placement of a POI object can be triggered based on the determination. In some implementations, software being executed on a device triggers placement of content by causing the device to place that content on one or more screens. For example, the POI object 324C can be docked at the side edge 328A based on the determination that the physical location 318C is behind and to the left of the device 312.

Turning now to the method 800, at 810 presentation of a map view or AR view can be triggered. For example, a map or AR area can be presented in the map mode or AR mode of the GUI 500 of FIGS. 5A-C.

At 820, an input such as a device tilt can be detected. For example, the tilt of the device 508 in FIGS. 5A-C can be detected.

At 830, a presence of a map can be scaled based on the detected tilt. For example, the map area (510, 510′, 510″) in FIGS. 5A-C can be scaled.

Turning now to the method 900, at 905 an increased inclination can be detected. For example, the tilt of the device 308 between the FIGS. 3A-B can be detected.

At 910, a physical location of a POI can be detected. For example, the physical locations 318A-C in FIG. 3A can be detected.

At 915, docking of a POI object at an edge can be triggered. In some implementations, software being executed on a device triggers docking of content by causing the device to dock that content on one or more screens. For example, the POI object 324B or 324C can be docked at the side edge 328A in FIG. 3B.

At 920, a rotation and/or movement relating to the device can be detected. For example, the rotation of the device 312 in FIG. 3C can be detected.

At 925, a physical location of a POI can be determined. For example, the physical locations 318A-C in FIGS. 3C and 3G can be determined.

At 930, a transition of a POI object can be triggered. In some implementations, software being executed on a device triggers transition of content by causing the device to transition that content on one or more screens. For example, the POI object 324C can be transitioned from the side edge 328A to the opposite side edge 328B in FIGS. 3D-G.

At 935, docking of the POI object at the other edge can be triggered. For example, the POI object can be docked at the opposite side edge 328B.

At 940, a rotation/movement relating to a device can be detected. For example, the device 312 in FIGS. 3C-G can be detected.

At 945, a physical location can be determined. For example, the physical location 318A in FIG. 3G can be determined.

At 950, placement of the POI object at an image location can be triggered. For example, in FIG. 3G the POI object 324A can be placed at a location within the AR area that corresponds to the physical location 318A.

Turning now to the method 1000, at 1010 a route can be defined. For example, the route 112 in FIG. 1A can be defined.

At 1020, presentation of a map with POI objects can be triggered. For example, the map area 104 with the POI object 114 can be presented in FIG. 1A.

At 1030, a transition to an AR mode can occur. For example, the GUI 100 can transfer to an AR mode as shown in FIG. 1B.

At 1040, placement of a next POI object of the route in the AR view can be triggered. For example, the POI object 128 can be placed in the AR view 116 because it is the next POI on the traveler's way along the route 112.

Turning finally to the method 1100, at 1110 presentation of a map can be triggered. For example, the map 402 in FIG. 4A can be presented.

At 1120, placement of a location legend on the map can be triggered. For example, the location legend 406 can be placed on the map 402 in FIG. 1A.

At 1130, a rotation can be detected. For example, the rotation of the device between FIGS. 4A-B can be detected.

At 1140, rotation of the map can be triggered. In some implementations, software being executed on a device triggers rotation of content by causing the device to rotate that content on one or more screens. For example, the map 402′ in FIG. 4B can be rotated as compared to the map 402 in FIG. 4A.

At 1150, rotation of an arrow symbol can be triggered. For example, the arrow symbol 406A in FIG. 4B can be rotated compared to FIG. 4A.

At 1160, a location of a remainder of the location legend can be maintained relative to the device. For example, in FIGS. 4B-C the remained of the location legend 406 remains in the same orientation relative to the device while the map (402, 402′, 402″) and the arrow symbol 406A are rotated.

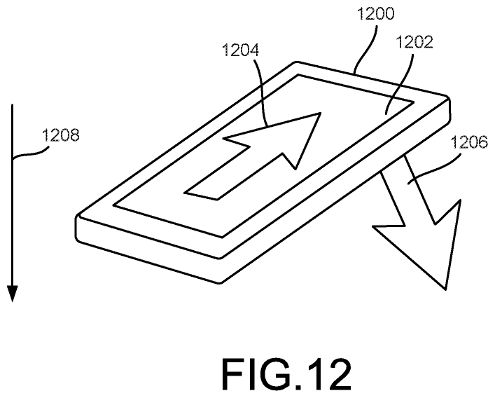

FIG. 12 schematically shows an example of transitioning between a map view and an AR view. This example is illustrated using a device 1200 having a screen 1202, such as a touchscreen. For example, any of the devices described elsewhere herein can be used.

Any of multiple mechanisms can be used for transitioning between a map mode and an AR mode in some implementations. One such example is by the user raising or tilting the phone. The pose can be tracked using a gyroscope and/or an accelerometer on the device 1200. As another example, a fully six-degrees of freedom (DOF) tracked phone can use GPS, a camera, or a compass. Based on the way the user holds the phone a transition can be initiated. When in a map or 2D mode, the direction of the phone can be determined by an “UP” vector 1204 of the screen 1202. A camera forward vector 1206 can also be determined. When the dot product of the camera forward vector 1206 with a gravity vector 1208 crosses a threshold, the device 1200 can transition into a 3D mode or an AR mode. In this case the device direction is the angle of the forward vector. This can enable holding the phone “UP” to reveal 3D mode and stay in 2D mode as long as the phone is held in a more natural reading position.

Another such example is by the user pressing a button. When the user presses a button, UI anchors and camera views can animate between modes in order to maintain spatial context.

Another such example is by the user pinching to zoom. When using multi-touch controls to zoom into the map, the transition could take place when the user zooms in or out beyond predefined thresholds.

Further embodiments are illustrated by the following examples.

### EXAMPLE 1

A method comprising operations as set out in any example described herein.

### EXAMPLE 2

A computer program product tangibly embodied in a non-transitory storage medium, the computer program product including instructions that when executed cause a processor to perform operations as set out in any example described herein.

### EXAMPLE 3

A system comprising: a processor; and a computer program product tangibly embodied in a non-transitory storage medium, the computer program product including instructions that when executed cause the processor to perform operations as set out in any example described herein.

FIG. 13 shows an example of a computer device and a mobile computer device that can be used to implement the techniques described here. FIG. 13 shows an example of a generic computer device 1300 and a generic mobile computer device 1350, which may be used with the techniques described here. Computing device 1300 is intended to represent various forms of digital computers, such as laptops, desktops, tablets, workstations, personal digital assistants, televisions, servers, blade servers, mainframes, and other appropriate computing devices. Computing device 1350 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 1300 includes a processor 1302, memory 1304, a storage device 1306, a high-speed controller 1308 connecting to memory 1304 and high-speed expansion ports 1310, and a low-speed controller 1312 connecting to low-speed bus 1314 and storage device 1306. The processor 1302 can be a semiconductor-based processor. The memory 1304 can be a semiconductor-based memory. Each of the components 1302, 1304, 1306, 1308, 1310, and 1312, are interconnected using various busses, and may be mounted on a common motherboard or in other manners as appropriate. The processor 1302 can process instructions for execution within the computing device 1300, including instructions stored in the memory 1304 or on the storage device 1306 to display graphical information for a GUI on an external input/output device, such as display 1316 coupled to high-speed controller 1308. In other implementations, multiple processors and/or multiple buses may be used, as appropriate, along with multiple memories and types of memory. Also, multiple computing devices 1300 may be connected, with each device providing portions of the necessary operations (e.g., as a server bank, a group of blade servers, or a multi-processor system).

The memory 1304 stores information within the computing device 1300. In one implementation, the memory 1304 is a volatile memory unit or units. In another implementation, the memory 1304 is a non-volatile memory unit or units. The memory 1304 may also be another form of computer-readable medium, such as a magnetic or optical disk.

The storage device 1306 is capable of providing mass storage for the computing device 1300. In one implementation, the storage device 1306 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 1304, the storage device 1306, or memory on processor 1302.

The high-speed controller 1308 manages bandwidth-intensive operations for the computing device 1300, while the low-speed controller 1312 manages lower bandwidth-intensive operations. Such allocation of functions is exemplary only. In one implementation, the high-speed controller 1308 is coupled to memory 1304, display 1316 (e.g., through a graphics processor or accelerator), and to high-speed expansion ports 1310, which may accept various expansion cards (not shown). In the implementation, low-speed controller 1312 is coupled to storage device 1306 and low-speed bus 1314. A low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 1300 may be implemented in a number of different forms, as shown in the figure. For example, it may be implemented as a standard server 1320, or multiple times in a group of such servers. It may also be implemented as part of a rack server system 1324. In addition, it may be implemented in a personal computer such as a laptop computer 1322. Alternatively, components from computing device 1300 may be combined with other components in a mobile device (not shown), such as device 1350. Each of such devices may contain one or more of computing device 1300, 1350, and an entire system may be made up of multiple computing devices 1300, 1350 communicating with each other.

Computing device 1350 includes a processor 1352, memory 1364, an input/output device such as a display 1354, a communication interface 1366, and a transceiver 1368, among other components. The computing device 1350 may also be provided with a storage device, such as a microdrive or other device, to provide additional storage. Each of the components 1350, 1352, 1364, 1354, 1366, and 1368, are interconnected using various buses, and several of the components may be mounted on a common motherboard or in other manners as appropriate.

The processor 1352 can execute instructions within the computing device 1350, including instructions stored in the memory 1364. The processor may be implemented as a chipset of chips that include separate and multiple analog and digital processors. The processor may provide, for example, for coordination of the other components of the computing device 1350, such as control of user interfaces, applications run by computing device 1350, and wireless communication by computing device 1350.

Processor 1352 may communicate with a user through control interface 1358 and display interface 1356 coupled to a display 1354. The display 1354 may be, for example, a TFT LCD (Thin-Film-Transistor Liquid Crystal Display) or an OLED (Organic Light Emitting Diode) display, or other appropriate display technology. The display interface 1356 may comprise appropriate circuitry for driving the display 1354 to present graphical and other information to a user. The control interface 1358 may receive commands from a user and convert them for submission to the processor 1352. In addition, an external interface 1362 may be provide in communication with processor 1352, so as to enable near area communication of computing device 1350 with other devices. External interface 1362 may provide, for example, for wired communication in some implementations, or for wireless communication in other implementations, and multiple interfaces may also be used.

The memory 1364 stores information within the computing device 1350. The memory 1364 can be implemented as one or more of a computer-readable medium or media, a volatile memory unit or units, or a non-volatile memory unit or units. Expansion memory 1374 may also be provided and connected to computing device 1350 through expansion interface 1372, which may include, for example, a SIMM (Single In Line Memory Module) card interface. Such expansion memory 1374 may provide extra storage space for computing device 1350, or may also store applications or other information for computing device 1350. Specifically, expansion memory 1374 may include instructions to carry out or supplement the processes described above, and may include secure information also. Thus, for example, expansion memory 1374 may be provide as a security module for computing device 1350, and may be programmed with instructions that permit secure use of device 1350. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 1364, expansion memory 1374, or memory on processor 1352, that may be received, for example, over transceiver 1368 or external interface 1362.

Computing device 1350 may communicate wirelessly through communication interface 1366, which may include digital signal processing circuitry where necessary. Communication interface 1366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through a radio-frequency transceiver (e.g., transceiver 1368). In addition, short-range communication may occur, such as using a Bluetooth, WiFi, or other such transceiver (not shown). In addition, GPS (Global Positioning System) receiver module 1370 may provide additional navigation- and location-related wireless data to computing device 1350, which may be used as appropriate by applications running on computing device 1350.

Computing device 1350 may also communicate audibly using audio codec 1360, which may receive spoken information from a user and convert it to usable digital information. Audio codec 1360 may likewise generate audible sound for a user, such as through a speaker, e.g., in a handset of computing device 1350. Such sound may include sound from voice telephone calls, may include recorded sound (e.g., voice messages, music files, etc.) and may also include sound generated by applications operating on device 1350.

The computing device 1350 may be implemented in a number of different forms, as shown in the figure. For example, it may be implemented as a cellular telephone 1380. It may also be implemented as part of a smart phone 1382, personal digital assistant, or other similar mobile device.

A user can interact with a computing device using a tracked controller 1384. In some implementations, the controller 1384 can track the movement of a user's body, such as of the hand, foot, head and/or torso, and generate input corresponding to the tracked motion. The input can correspond to the movement in one or more dimensions of motion, such as in three dimensions. For example, the tracked controller can be a physical controller for a VR application, the physical controller associated with one or more virtual controllers in the VR application. As another example, the controller 1384 can include a data glove.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in FIG. 13 can include sensors that interface with a virtual reality (VR headset 1385). For example, one or more sensors included on a computing device 1350 or other computing device depicted in FIG. 13, can provide input to VR headset 1385 or in general, provide input to a VR space. The sensors can include, but are not limited to, a touchscreen, accelerometers, gyroscopes, pressure sensors, biometric sensors, temperature sensors, humidity sensors, and ambient light sensors. The computing device 1350 can use the sensors to determine an absolute position and/or a detected rotation of the computing device in the VR space that can then be used as input to the VR space. For example, the computing device 1350 may be incorporated into the VR space as a virtual object, such as a controller, a laser pointer, a keyboard, a weapon, etc. Positioning of the computing device/virtual object by the user when incorporated into the VR space can allow the user to position the computing device to view the virtual object in certain manners in the VR space. For example, if the virtual object represents a laser pointer, the user can manipulate the computing device as if it were an actual laser pointer. The user can move the computing device left and right, up and down, in a circle, etc., and use the device in a similar fashion to using a laser pointer.

In some implementations, one or more input devices included on, or connect to, the computing device 1350 can be used as input to the VR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 1350 when the computing device is incorporated into the VR space can cause a particular action to occur in the VR space.

In some implementations, a touchscreen of the computing device 1350 can be rendered as a touchpad in VR space. A user can interact with the touchscreen of the computing device 1350. The interactions are rendered, in VR headset 1385 for example, as movements on the rendered touchpad in the VR space. The rendered movements can control objects in the VR space.

In some implementations, one or more output devices included on the computing device 1350 can provide output and/or feedback to a user of the VR headset 1385 in the VR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 1350 may appear as another object in a computer-generated, 3D environment. Interactions by the user with the computing device 1350 (e.g., rotating, shaking, touching a touchscreen, swiping a finger across a touch screen) can be interpreted as interactions with the object in the VR space. In the example of the laser pointer in a VR space, the computing device 1350 appears as a virtual laser pointer in the computer-generated, 3D environment. As the user manipulates the computing device 1350, the user in the VR space sees movement of the laser pointer. The user receives feedback from interactions with the computing device 1350 in the VR space on the computing device 1350 or on the VR headset 1385.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

1. A method comprising:
triggering presentation of at least a portion of a map on a device that is in a map mode, wherein a first point of interest (POI) object is placed on the map, the first POI object representing a first POI located at a first physical location;
detecting, while the map is presented, an input triggering a transition of the device from the map mode to an augmented reality (AR) mode;
triggering presentation of an AR view on the device in the AR mode, the AR view including an image captured by a camera of the device, the image having a field of view;
determining whether the first physical location of the first POI is within the field of view; and
in response to determining that the first physical location of the first POI is not within the field of view, triggering placement of the first POI object at a first edge of the AR view.

2. The method of claim 1, further comprising determining that the first edge is closer to the first physical location than other edges of the AR view, wherein the first edge is selected for placement of the first POI object based on the determination.

3. The method of claim 2, wherein determining that the first edge is closer to the first physical location than the other edges of the AR view comprises determining a first angle between the first physical location and the first edge, determining a second angle between the first physical location and a second edge of the image, and comparing the first and second angles.

4. The method of claim 1, wherein detecting the input comprises, in the map mode, determining a vector corresponding to a direction of the device using an up vector of a display device on which the map is presented, determining a camera forward vector, and evaluating a dot product between the vector and a gravity vector.

5. The method of claim 1, wherein the first POI object is placed at the first edge of the AR view, the method further comprising:
detecting a relative movement between the device and the first POI; and
in response to the relative movement, triggering cessation of presentation of the first POI object at the first edge, and instead triggering presentation of the first POI object at a second edge of the image opposite the first edge.

6. The method of claim 5, wherein triggering cessation of presentation of the first POI object at the first edge comprises triggering gradual motion of the first POI object out of the AR view at the first edge so that progressively less of the first POI object is visible until the first POI object is no longer visible at the first edge.

7. The method of claim 5, wherein triggering presentation of the first POI object at the second edge comprises triggering gradual motion of the first POI object into the AR view at the second edge so that progressively more of the first POI object is visible until the first POI object is fully visible at the second edge.

8. The method of claim 5, further comprising, after triggering cessation of presentation of the first POI object at the first edge, pausing for a predetermined time before triggering presentation of the first POI object at the second edge.

9. The method of claim 5, wherein the first physical location of the first POI is initially outside of the field of view and on a first side of the device, and wherein detecting the relative movement comprises detecting that the first physical location of the first POI is instead outside of the field of view and on a second side of the device, the second side opposite to the first side.

10. The method of claim 1, wherein triggering presentation of the map comprises:
determining a present inclination of the device; and
causing the portion of the map to be presented, the portion being determined based on the present inclination of the device.

11. The method of claim 10, wherein the determination comprises applying a linear relationship between the present inclination of the device and the portion.

12. The method of claim 10, wherein the transition of the device from the map mode to the AR mode, and a transition of the device from the AR mode to the map mode, are based on the determined present inclination of the device without use of a threshold inclination.

13. The method of claim 1, wherein at least a second POI object in addition to the first POI object is placed on the map in the map view, the second POI object corresponding to a navigation instruction for a traveler to traverse a route, the method further comprising:
detecting a rotation of the device;
in response to detecting the rotation, triggering rotation of the map based on the rotation of the device; and
triggering rotation of at least part of the second POI object corresponding to the rotation of the map.

14. The method of claim 13, wherein the second POI object comprises an arrow symbol placed inside a location legend, wherein the part of the second POI object that is rotated corresponding to the rotation of the map includes the arrow symbol, and wherein the location legend is not rotated corresponding to the rotation of the map.

15. The method of claim 14, wherein the location legend is maintained in a common orientation relative to the device while the map and the arrow symbol are rotated.

16. The method of claim 1, wherein multiple POI objects in addition to the first POI object are presented in the map view, the multiple POI objects corresponding to respective navigation instructions for a traveler to traverse a route, a second POI object of the multiple POI objects corresponding to a next navigation instruction on the route and being associated with a second physical location, the method further comprising:
when the AR view is presented on the device in the AR mode, triggering presentation of the second POI object at a location on the image corresponding to the second physical location, and not triggering presentation of a remainder of the multiple POI objects other than the second POI object on the image.

17. The method of claim 1, further comprising triggering presentation, in the map mode, of a preview of the AR view.

18. The method of claim 17, wherein triggering presentation of the preview of the AR view comprises:
determining a present location of the device;
receiving an image from a service that provides panoramic views of locations using an image bank, the image corresponding to the present location; and
generating the preview of the AR view using the received image.

19. The method of claim 18, further comprising transitioning from the preview of the AR view to the image in the transition of the device from the map mode to the AR mode.

20. The method of claim 1, further comprising, in response to determining that the first physical location of the first POI is within the field of view, triggering placement of the first POI object at a location in the AR view corresponding to the first physical location.

21. A computer program product tangibly embodied in a non-transitory storage medium, the computer program product including instructions that when executed cause a processor to perform operations, the operations comprising:
triggering presentation of at least a portion of a map on a device that is in a map mode, wherein a first point of interest (POI) object is placed on the map, the first POI object representing a first POI located at a first physical location;
detecting, while the map is presented, an input triggering a transition of the device from the map mode to an augmented reality (AR) mode;
triggering presentation of an AR view on the device in the AR mode, the AR view including an image captured by a camera of the device, the image having a field of view;
determining whether the first physical location of the first POI is within the field of view; and
in response to determining that the first physical location of the first POI is not within the field of view, triggering placement of the first POI object at a first edge of the AR view.

22. A system comprising:
a processor; and
a computer program product tangibly embodied in a non-transitory storage medium, the computer program product including instructions that when executed cause the processor to perform operations, the operations comprising:
triggering presentation of at least a portion of a map on a device that is in a map mode, wherein a first point of interest (POI) object is placed on the map, the first POI object representing a first POI located at a first physical location;
detecting, while the map is presented, an input triggering a transition of the device from the map mode to an augmented reality (AR) mode;
triggering presentation of an AR view on the device in the AR mode, the AR view including an image captured by a camera of the device, the image having a field of view;
determining whether the first physical location of the first POI is within the field of view; and
in response to determining that the first physical location of the first POI is not within the field of view, triggering placement of the first POI object at a first edge of the AR view.
